(19) United States
(12) Patent Application Publication
(10) Pub. No.: US 2026/0161644 A1
(43) Pub. Date: Jun. 11, 2026

(54) RETRIEVING CONTENT ITEMS FOR A RECEIVED REQUEST BY APPLYING A TOOL SELECTION MODEL AND ASSOCIATED QUERY BUILDING MODELS TO THE REQUEST TO SELECT CONTENT ITEMS

(71) Applicant: Mango Technologies, Inc. DBA ClickUp, San Diego, CA (US)

(72) Inventors: Elliot Pourmand, Berkeley, CA (US); Arman Ashrafian, San Francisco, CA (US)

(21) Appl. No.: 18/971,148

(22) Filed: Dec. 6, 2024

(51) Int. Cl. G06F 16/2452; G06F 16/242; G06F 16/2457

(52) U.S. Cl. CPC G06F 16/24522; G06F 16/2423; G06F 16/24578

(57) ABSTRACT

A task management system stores different types of content items, such as tasks, data objects, or interactions with tasks. Different content items may be stored in different formats. To simplify retrieval of content items in different formats, the task management system receives a request comprising unstructured text. Through application of a tool selection model, the task management system determines a tool for the request. Based on the determined tool, the task management system retrieves a set of query building models and applies the set of query building models to the request. Features generated by the set of query building models are combined into a structured language query that is executed to retrieve content items. A result generation model is applied to the retrieved content items and a formatting instruction corresponding to the determined tool to generate results.

### BACKGROUND

Users store an increasing amount of information with various online systems, simplifying access to the information by the users from different locations or from different client devices. An online system may store different types of data in different formats or different online systems store data in different formats. Using different formats to store different types of data allows online systems to optimize use of storage resources, to optimize an amount of time for retrieving data, or to optimize another parameters for data retrieval or data storage.

While storing different types of data in different formats provides online systems with greater flexibility for optimizing one or more resources for data storage, different formats for data storage often use different instructions or different syntax structures for instructions or commands to identify or to retrieve stored data. Variations in syntax for instructions or commands to retrieve different types of data increases complexity for users when retrieving data. For example, instructions for retrieving data stored in different formats differently identify attributes of data or include different commands to retrieve. Because of disparate syntax for instructions to retrieve different data, users of conventional online systems determine a type of data to retrieve and manually input instructions for retrieving data with a syntax corresponding to the determined type of data. This manual entry of instructions with different syntaxes to retrieve different types of data increases an amount of time for users to create instructions for retrieving data and increases an amount of interaction with an online system for a user to manually input instructions for retrieving different types of data. Having to discern between multiple syntaxes for data retrieval instructions decreases a frequency with which a user interacts with an online system.

### SUMMARY

In accordance with one or more aspects of the disclosure, a task management system receives tasks from user. Each task identifies an action be performed and includes a performing user assigned to perform the action. Further, each task is associated with one or more attributes providing information about the task. The task management system stores the received tasks and their corresponding attributes for subsequent retrieval. For example, the task management system maintains a task log in a data store, with the task log including an entry for each task. An entry for a task includes attributes of the task and a task identifier of the task.

Additionally, users of the task management system perform interactions with one or more tasks, with an interaction with a task modifying one or more attributes of the task. In various embodiments, the task management system maintains an interaction log as a record of interactions performed by users over time. For example, the task management system maintains a task log that includes an entry for each interaction, with an entry including an identifier of an interaction and attributes of the interaction. Further, the task management system may obtain other data objects associated with a user from one or more third party systems in response to the user authorizing the task management system to access the third party system and to access the data objects associated with the user by the third party system. Example data objects include files, documents, video data, audio data, image data, or other data with one or more attributes. The task management system may locally store data objects obtained from a third party system. For example, the task management system maintains content databases for different third party systems, with a data object from a third party system stored in a database corresponding to the third party system. For clarity, the term “content item” is used herein to refer to discrete portions of data with one or more attributes that are stored, or accessible, by the task management system. For example, a content item may be a task, an interaction, a user profile, a file, a data object, or another type of data stored by the task management system and having one or more corresponding attributes stored by the task management system.

To optimize storage resources or to optimize retrieval time of content items or attributes of content items, the task management system stores data about different types of content items in different formats. For example, the task log for tasks comprises a database with specific fields corresponding to different attributes, while the interaction log comprises a separate database with different fields corresponding to various attributes of an interaction. Different databases may be maintained for different types of content items, with each database storing different attributes for a corresponding type of content item. Storing different types of content items in different formats causes instructions or commands with different formats and including different information to be used for retrieving content items from different databases. For example, an instruction for retrieving a task from the task log has a different syntax and identifies different attributes of a task than an instruction for retrieving an interaction from the interaction log. This variation in syntax for instructions for retrieving different types of content items increases complexity of a user retrieving different types of content items. Determining an appropriate format for instructions to retrieve different types of content items increases an amount of time spent by a user to retrieve content items or increases an amount of interaction by the user with the task management system to retrieve various content items, which may reduce subsequent interaction by the user with the task management system.

To simplify retrieval of content items, regardless of type, the task management system receives a request to retrieve one or more content items from a user. For example, the request comprises natural language or unstructured text. In various embodiments, the request includes one or more values of attributes of content items to retrieve. For example, the request includes a specific keyword as a value for an attribute of a content item or includes a time range within which a value of another attribute of a content item is included.

The task management system applies a tool selection model to the received request. In various embodiments, the task management system maintains a set of tools for obtaining results based on the request. Different tools of the set correspond to different expected results based on the request, so different tools cause different retrieval of content items or inclusion of different information about retrieved content items in results generated for the request. For example, a first tool of the set corresponds to expected results of an aggregated number of content items (e.g., tasks,), while a second tool of the set corresponds to expected results of a listing of content items having a value included in the request for an attribute. In various embodiments, the set of tools maintained by the task management system includes different numbers of tools in the set.

The tool selection model is a generative model pre-trained on a text corpus to determine relationships between different tokens (e.g., different words, different phrases) included in an input before being obtained by the task management system. For example, the tool selection model is a large language model, such as a generative pre-trained transformer model. The task management system further tunes the tool selection model to determine a tool from the set of tools for the request by applying the tool selection model to tool selection examples. Each tool selection example includes an example request, with a label applied to a tool selection example indicating a tool corresponding to the example request. In some embodiments, the tool selection example includes contextual information associated with the example request. When the task management system applies the tool selection model to a tool selection example, the task management system modifies at least a set of parameters comprising the tool selection model based on a difference between a predicted tool output by the tool selection model for the tool selection example and the label applied to the tool selection example. This modification of one or more parameters of the tool selection model improves an accuracy with which the tool selection model determines a tool for the request based on correspondences between example requests and tools.

In various embodiments, the task management system stores one or more types of contextual information describing the user from whom the request was received and additional requests received from the user from whom the request was received. Contextual information may be stored in the data store and retrieved by the task management system when applying the tool selection model to the request. One or more different types of contextual information may be retrieved and combined with the request. A type of contextual information comprises global contextual information about the user from whom the request was received and the request. Examples of global contextual information include a user identifier of the user, an indication of tasks the user is authorized to access, an attribute of tasks associated with the user, or other information describing the user or the request.

Another type of contextual information comprises historical request contextual information including prior requests the task management system received from the user and attributes of the prior requests. In some embodiments, the historical request contextual information includes attributes of prior requests received from the user during a specific time interval. For example, the historical request contextual information includes prior requests the task management system received after the user selects a specific interface element or after the task management system receives a specific instruction from the user. The historical request contextual information is limited to prior requests received from the user during a time interval when the user is logged in to the task management system using authentication information for the user in some embodiments. For each prior request, the task management system stores the content included in the prior request (e.g., text comprising the prior request) and maintains one or more attributes for the prior request. Example attributes of a prior request include: prior results generated by the task management system in response to the prior request, a tool determined for the prior request, a structured language query generated by the task management system for the prior request, additional contextual information about the prior request retrieved and included in the structured language query generated for the prior request, or other information associated with the prior request. Different types of characteristics of the user may be included in the global contextual information or different attributes associated with prior requests may be included in the historical request contextual information in various embodiments. The task management system may retrieve different sets of contextual information the tool selection model receives in conjunction with the request in different embodiments.

Application of the tool selection model to the request, as well as contextual information in some embodiments, determines a tool for the request. Based on the tool determined for the request, the task management system selects a set of query building models for application to the request to generate a structured language query. The task management system stores associations between each tool of the set of tools and a corresponding set of query building models. While different tools are associated with different sets of query building models, one or more query building models may be included in multiple sets of query building models associated with different tools. In some embodiments, each tool of the set of tools is associated with a single query building model, while in other embodiments, multiple query building models are associated with a tool. Further, different numbers of query building models may be included in sets of query building models associated with different tools of the set of tools.

The task management system selects a set of query building models associated with the tool determined for the request and applies each query building model of the set to the request. In various embodiments, each query building model of the set receives the request and associated contextual information as input. Different query building models of the selected set may retrieve different contextual information in association with the request. For example, a first query building model receives the request and global contextual information associated with the request as input, while a second query building model receives the request and historical request contextual information associated with the request as input. A query building model of the set generates one or more features of the structured language query based on the request and contextual information. For example, different query building models generate different combinations of a value of an attribute and an identifier of an attribute or generate parameters for different commands based on the request and contextual information associated with the request. Hence, the set of query building models converts the unstructured or natural language text of the request into features representing different portions of a query having a specific syntax.

In various embodiments, each query building model is a generative model pre-trained on a text corpus including text to learn relationships between different tokens within text received as input. For example, the query building model is a large language model (LLM), such as a generative pre-trained transformer model (GPT). While pre-training the query building model on the text corpus allows the query building model to learn relationships between different tokens (e.g., different words, different phrases) in an input, the task management system further tunes a query building model to generate one or more features of the structured language query from a request and contextual information associated with the request through a backpropagation process from application to query building training examples. A query building training example includes an example request and contextual information associated with the example request, with a label applied to the query building training example identifying one or more features based on the example request and contextual information associated with the example request. Applying the query building model to a query building training example generates a predicted feature. The task management system modifies one or more parameters of the query building model based on a difference between the predicted feature and the label applied to the query building training example to tune the query building model. Hence, applying the query building model to query building training examples optimizes the more general pre-training of the query building model based on the text corpus to generate features of the structured language query based on the request and associated contextual information.

In various embodiments, the task management system generates the structured language query for the request by combining features generated by each query building model of the set of query building models selected based on the tool determined for the request. For example, the task management system stores syntax information for different structured language queries that correspond to different tools of the set of tools. Different structured language queries have different syntaxes and include different features, allowing different tools to account for different syntaxes for structured language queries. In various embodiments, the syntax information includes an identifier of one or more sources from which content items are obtained. The task management system combines features generated by different query building models subject to the syntax information associated with the tool determined for the request to generate the structured language query for the request. For example, the structured language query comprises an application programming interface (API) call including instructions and features generated by the one or more query building models that are combined subject to syntax information associated with the tool determined for the request. However, in other embodiments, the structured language query has an alternative format.

The task management system executes the structured language query to retrieve one or more content items. The structured language query specifies a source from which the task management system retrieves content items in various embodiments. Example sources from which content items are retrieved include the task log, an interaction log, or a data object store included in the data store of the task management system. As another example, a source of one or more content items is a third party system. The task management system may retrieve the content items based on the structured language query from multiple sources in some embodiments. Each content item retrieved based on the structured language query has a value of at least one attribute matching a value included in the structured language query. Hence, the tool selection model and the corresponding set of query building models generate a structured language query based on the request, with the structured language query executed by the task management system to retrieve content items based on values for one or more attributes included in the request.

To simplify review or evaluation of information about content items retrieved based on the structured language query, the task management system ranks the retrieved content items. In some embodiments, the task management system generates a score for each content item based on values of attributes of a retrieved content item. The task management system may retrieve supplemental attributes of a retrieved content item that are used to determine the score for the content item in some embodiments. Example supplemental attributes include a number of interactions with the retrieved content item, a number of a specific interaction performed with the retrieved content item, comments with the retrieved content item, a frequency with which users accessed the content item, or other supplemental attributes describing interaction with the retrieved content item. The score of a retrieved content item provides a measure of relevance of the content item to the user from whom the request was received. In various embodiments, the score for a retrieved content item is based on values of attributes of the retrieved content item, and may also be based on supplemental attributes obtained for the retrieved content item. The task management system ranks the retrieved content items based on their scores, with content items having higher scores having higher positions in the ranking.

In various embodiments, the task management system generates different rankings for content items retrieved from different sources. For example, the task management system generates a source-specific ranking for each source from which content items were retrieved. A source-specific ranking for a particular source of retrieved content items ranks the content items retrieved from the particular source. Generating source-specific rankings for content items 4retrieved from different sources, allows the task management system to account for different attributes of content items maintained by different sources. When the task management system generates source-specific rankings for content items retrieved from different sources, the task management system subsequently generates a combined ranking including content items retrieved from a plurality of sources. The combined ranking may be based on scores generated for source-specific rankings for content items. Alternatively, the task management system generates an alternative score for each retrieved content item based on attributes of each retrieved content item and ranks the retrieved content items for the combined ranking based on the alternative scores. In some embodiments, the task management system generates the alternative score for a retrieved content item by applying a conversion factor to the score generated for the source-specific ranking for the retrieved content item. The combined ranking allows the task management system 130 to provide an order of content items 445 retrieved from different sources relative to each other based on measures of relevance to the user from whom the request was received.

Based on the ranking of the retrieved content items and a formatting instruction associated with the tool determined for the request, the task management system generates a prompt for a result generation model. The formatting instruction describes a format in which information about at least a set of the retrieved content items is presented to the user from whom the request was received. In various embodiments, the task management system determines the formatting instruction based on the tool determined for the request and appends the formatting instruction to retrieved content items and their associated attributes ordered based on the ranking to generate the prompt. For example, the task management system maintains a tool index having an entry for each tool of the set. An entry includes an identifier of a tool, a set of query building models associated with the tool, and a formatting instruction associated with the tool. The task management system identifies the determined tool in the tool index and selects the formatting instruction associated with the determined tool from the tool index. In various embodiments, the formatting instruction comprises an example set of content items and example results presenting content about the example set of content items to present. The formatting instruction identifies the information about retrieved content items to include in results and information for how the identified information is presented to the user from whom the request was received. Including the formatting instruction in the prompt provides the result generation model with an indication of information to include in the results and how to format the information included in the results.

Applying the result generation model to the prompt generates results including information about at least a set of the retrieved content items. In various embodiments, the result generation model is a generative model, such as a large language model (LLM). The result generation model is pre-trained through application to a text corpus before being obtained by the task management system. Application to the text corpus allows the result generation model 460 to learn relationships between different tokens (e.g., different words or phrases) comprising an input, which the result generation model leverages to generate results based on tokens included in the prompt. Including the formatting instruction in the prompt provides the result generation model with an expected format for content in the results, which the result generation model uses in combination with the learned relationships between tokens in the prompt to generate results presenting information about the content items formatted based on the formatting instruction. For example, in response to a first formatting instruction, the result generation model generates results including a total number of content items that were retrieved, while in response to an alternative formatting instruction, the result generation model generates results identifying each retrieved content item and one or more attributes associated with each retrieved content item.

The task management system transmits the results to a client device of the user from whom the request was received, which presents the results to the user. In various embodiments, a task management application executing on the client device displays the results in a portion of an interface. The task management application or the task management system may modify a rate at which portions of the results are displayed or presented to the user based on a portion of the results that has been presented relative to a size of the results. This allows portions of the results to be presented at a different rate based on the amount of the results that have been presented and the amount of the results that have yet to be presented. Such variable presentation of the results prevents delays in obtaining different portions of the results for display over time, making presentation of the results more fluid. However, in other embodiments, the task management system or the task management application differently present the results to the user.

Applying the tool selection model to the request and subsequently applying a set of query building models based on a determined tool to the request generates a structured language query based on the request. As the task management system stores different types of content items, such as tasks, data objects, or interactions, in different formats, queries for retrieving different types of content items have different syntaxes or include different information. The tool selection model and the set of query building models simplify retrieval of content items by converting the request, which may be unstructured text, into an appropriately formatted structured language query for retrieving content items based on the content of the request (as well as contextual information about the request in various embodiments). Subsequently, the task management system retrieves content items based on the structured language query and generates results by applying the result generation model to the retrieved content items. The results include information about one or more of the retrieved content items and present the information about one or more of the retrieved content items in a format based on the determined tool, reducing an amount of time for the user to review or to evaluate the results. Hence, the task management system leverages the tool selection model, a set of query building models selected based on the output of the tool selection model, and the results generation model to simplify retrieval of content items and presentation of information about retrieved content items for a user.

### BRIEF DESCRIPTION OF THE DRAWINGS

FIG. 1 illustrates an example system environment for a task management system, in accordance with one or more embodiments.

FIG. 2 illustrates an example system architecture for a task management system, in accordance with one or more embodiments.

FIG. 3 illustrates a flowchart of a method for retrieving stored content items using a structured language query generated by a set of generative models based on a received request, in accordance with one or more embodiments.

FIG. 4 illustrates a process flow diagram of a method for retrieving stored content items using a structured language query generated by a set of generative models based on a received request, in accordance with one or more embodiments.

### DETAILED DESCRIPTION

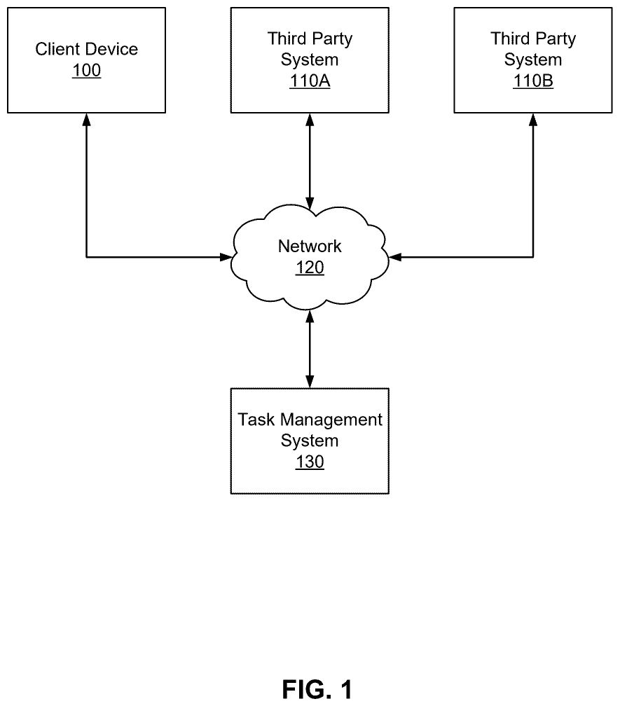

FIG. 1 illustrates an example system environment for a task management system 130, in accordance with one or more embodiments. The system environment illustrated in FIG. 1 includes a client device 100, one or more third party systems 110A, 110B (also referred to individually and collectively using reference number 110), a network 120, and a task management system 130. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

For purposes of illustration, FIG. 1 shows a single client device 100 for purposes of illustration. However, any number of client devices 100 may be included in the system environment. As such, there may be more than one client device 100 in various embodiments. The client device 100 is a device through which a user may interact with one or more third party systems 110 or with the task management system 130. The client device 100 may be a personal computing device or a mobile computing device, such as a smartphone, a tablet, a laptop computer, or desktop computer. In some embodiments, the client device 100 executes a task management application that uses an application programming interface (API) to communicate with the task management system 130.

Through interaction with the task management application executing on the client device 100, a user creates one or more tasks that are stored by the task management system 130, as further described below. Each task corresponds to one or more actions to be performed, and a performing user is assigned to a task. The performing user is assigned to complete the one or more actions corresponding to a task. The performing user may be the user who created the task or may be a different user. Additionally, the user may specify one or more attributes of a task, as well as values of one or more attributes. Example attributes of a task include the performing user assigned to the task, a status of the task, a due date for the task, a priority level of the task, a resource allocation (e.g., a budget) for performing the task, one or more comments about the task, one or more users authorized to view the task, or other information relevant to performing an action corresponding to the task.

In various embodiments, the task management application executing on the client device 100 presents a workflow management interface to the user. The workflow management interface is a user interface that receives input from the user to identify tasks, to create tasks, to generate a list of related tasks, to generate a hierarchy of tasks, to assign a performing user to a task, to modify one or more attributes of a task, or to perform other interactions affecting one or more tasks. In various embodiments, the workflow management interface allows the user to search the task management system 130 for tasks satisfying one or more attributes specified by the user and accessible to the user. The workflow management interface also allows a user to generate one or more reports describing tasks, such as a report identifying interactions with one or more tasks performed by an identified performing user. Additionally, the workflow management interface includes one or more messaging elements allowing the user to provide messages for transmission to one or more receiving users of the task management system 130.

In some embodiments, the task management application also generates and presents a communication interface to the user that allows the user to communicate messages to the task management system 130, to a receiving user of the task management system 130, or to a third party system 110. A message may include text data, audio data, image data, video data, or any combination thereof. For example, a message is a text message or a chat message. The client device 100 transmits a message via the network 120 and may receive one or more messages via the network 120. The communication interface may also display messages received from the task management system 130, from a third party system 110, or from another client device 100 to the user. In some embodiments, the communication interface may allow the user of the client device 100 and another user to communicate through audio or video communications, such as a phone call, a voice-over-Internet-Protocol (VoIP) call, or a video call.

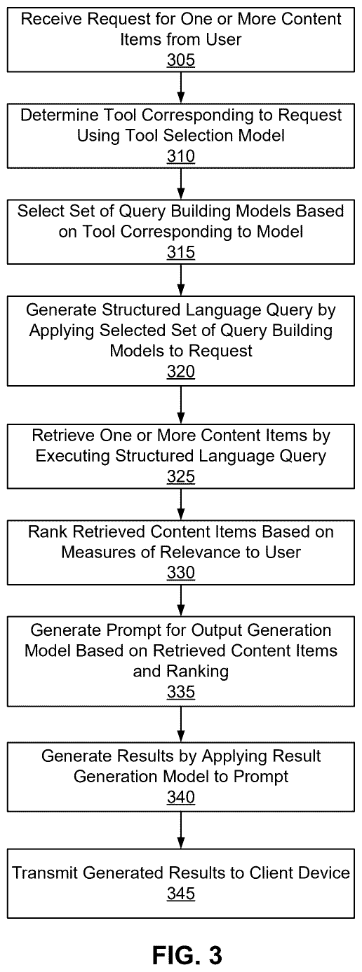

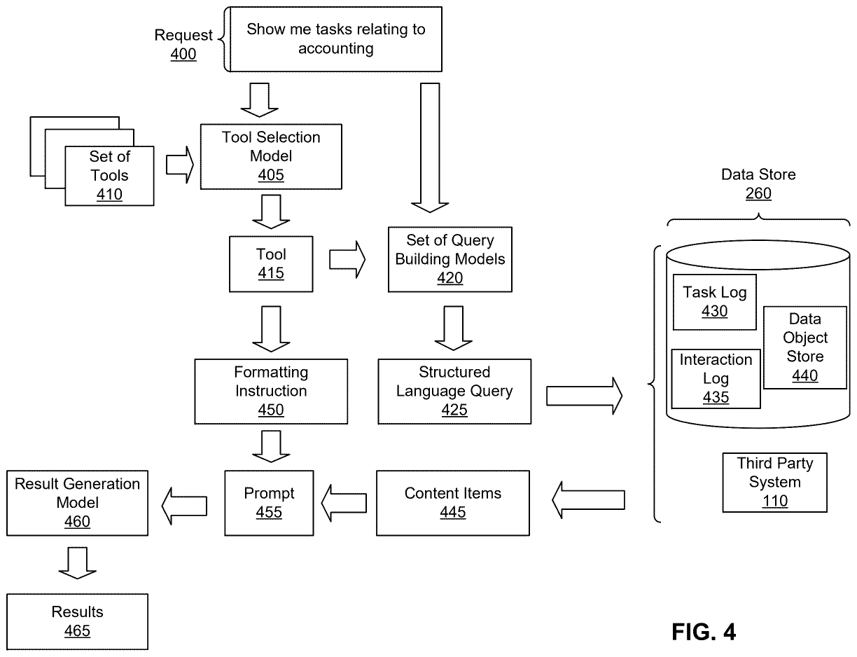

In various embodiments, the task management application presents one or more interfaces to a user for providing a request to obtain one or more content items from the task management system 130. As used herein, a “content item” is a discrete portion of data maintained by the task management system 130, or accessible to the task management system 133, and having one or more attributes. Examples of a content item include a task, an interaction with a task, a file, a user profile, a document, video data, audio data, or another data object. In various embodiments, the request comprises unstructured or natural language text that includes one or more specific values for one or more attributes of content items. As further described below in conjunction with FIGS. 3 and 4, in response to receiving a request, the task management system 130 retrieves one or more content items each having a value of an attribute at least partially matching a value included in the request. The task management system 130 generates and transmits results including information about one or more retrieved content items based on the request to the client device 100, which displays the results in the interface. As further described below in conjunction with FIGS. 3 and 4, the task management system 130 leverages one or more trained models to retrieve content items based on the request, allowing the user to provide unstructured text as the request that the one or more trained models convert into a structured language query for retrieving content items.

The client device 100 may receive additional content from the task management system 130 to present to a customer. For example, the client device receives notifications from the task management system 130 and presents the notifications to the customer. For example, a notification received from the task management system 130 identifies a modification to an attribute of a task associated with the user (e.g., a change in a status of the task).

A third party system 110 is a computing system separate from the task management system 130 that interacts with the task management system 130 or with the client device 100. In various embodiments, different third party systems 110A, 110B provide different types of content to the task management system 130 or to the client device 100. For example, a third party system 110 is an application provider communicating information describing one or more applications for execution by a client device 100 or communicating data to a client device 100 for use by an application executing on the client device 100. In other embodiments, a third party system 110 provides content (e.g., web pages, video content, etc.) or other information for presentation via a client device 100. A third party system 110 may also communicate information to the task management system 130, such as files, documents, metadata, or other information to the task management system 130.

The client device 100, the one or more third party systems 110, and the task management system 130 can communicate with each other via the network 120. The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical media for communicating data from one computing device to another computing device, such as multiprotocol label switching (MPLS) lines, fiber optic cables, cellular connections (e.g., 3G, 4G, or 5G spectra), or satellites. The network 120 also may use networking protocols, such as transmission control protocol/internet protocol (TCP/IP), hypertext transfer protocol (HTTP), secure shell protocol (SSH), short message service (SMS), multimedia messaging service (MMS), rich communication services (RCS) or file transfer protocol (FTP), to transmit data between computing devices. In some embodiments, the network 120 may include BLUETOOTH® or near-field communication (NFC) technologies or protocols for local communications between computing devices. The network 120 may transmit encrypted or unencrypted data.

The task management system 130 is an online system where users identify tasks specifying actions to be performed, assign a performing user to perform an action identified by a task, and specify attributes of the task. The task management system 130 maintains associations between users and tasks. For example, the task management system 130 stores an association between a task identifier of a task, one or more user identifiers of performing users associated with the task, and a user identifier of a user who created the task. The task management system 130 receives an interaction with a task from a user and modifies one or more attributes of the task based on the interaction. Additionally or alternatively, the task management system 130 may modify one or more attributes of a task based on received information describing interactions performed by a user. In some embodiments, the task management system 130 transmits a notification to a client device 100 of a user associated with a task in response to an attribute of the task being modified to inform the user associated with the task when an attribute of the task is modified.

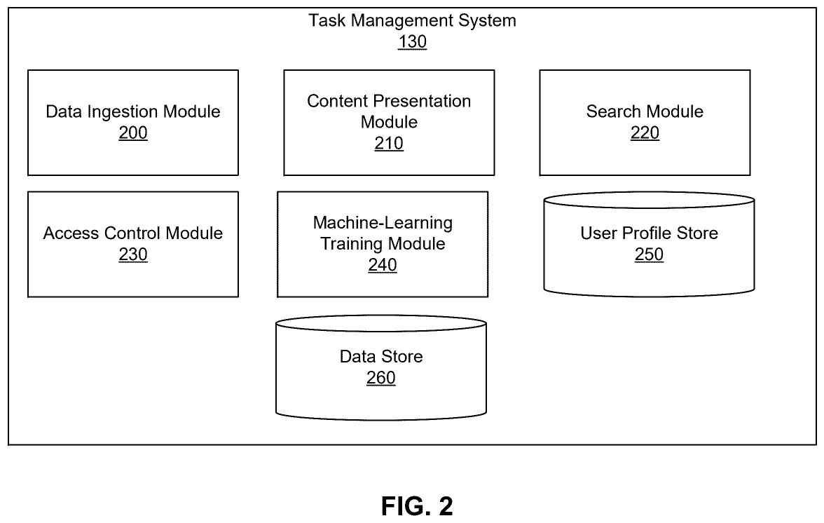

Additionally, the task management system 130 may generate one or more interfaces for a user associated with one or more tasks. For example, an interface identifies tasks associated with a user and identifies at least a set of attributes of the identified tasks, allowing the user to readily review and identify attributes of different tasks. The interface may identify relationships between tasks or between tasks and one or more sub-tasks of a task identified by a user, allowing the user to readily ascertain relationships between different tasks. Further, the task management system 130 may store files or other data associated with a task or store information for retrieving files or data associated with the task from a third party system 110 to simplify access to data for reviewing or for performing a task for a user. The task management system 130 is described in further detail in conjunction with FIG. 2.

FIG. 2 illustrates an example system architecture for a task management system 130, in accordance with some embodiments. The system architecture illustrated in FIG. 2 includes a data ingestion module 200, a content presentation module 210, a search module 220, an access control module 230, a machine learning training module 240, a user profile store 250, and a data store 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data ingestion module 200 collects data used by the task management system 130 and stores the data in the user profile store 250 or in the data store 260. For example, the data ingestion module 200 receives information for creating a task from a user. Information for creating a task includes a description of the task, a performing user assigned to the task, and one or more attributes of the task. Values of one or more attributes may also be received from the user, or the data ingestion module 200 may specify default values for one or more attributes of a task. The data ingestion module 200 also receives modifications to one or more values of attributes of a task from a user. Additionally, the data ingestion module 200 receives information from a user including characteristics of a user for inclusion in a corresponding user profile. The data ingestion module 200 may encrypt some or all of the obtained data, such as certain data describing a user.

The data ingestion module 200 also receives data describing relationships between tasks from a user or from a third party system 110. For example, a user may identify one or more discrete sub-tasks that correspond to different portions of a task, and the data ingestion module 200 extracts information identifying the task and the sub-tasks associated with the task. Further, the data ingestion module 200 may receive data describing a hierarchy of tasks. For example, the data ingestion module 200 receives an identifier of a list from a user along with identifiers of one or more tasks to associate with the list. Hence, the list includes one or more tasks, allowing a user to organize related tasks, tasks related to a common objective, or tasks having one or more other common criteria. Additional hierarchical information may be specified in some embodiments. For example, the data ingestion module 200 receives an identifier of a category and identifiers of one or more lists associated with the category, allowing a user to generate a grouping of lists, and the tasks included in the lists. Received data describing a hierarchical relationship between tasks is stored in the data store 260 by the data ingestion module 200.

Additionally, the data ingestion module 200 captures interactions by users with tasks and stores the interactions in an interaction log included in the data store 260. In various embodiments, when a user interacts with a task through the task management system 130, the data ingestion module 200 determines a user identifier of the user, a task identifier of the task with which the user interacted, a time when the interaction occurred, and a description of the interaction by the user with the task. When the interaction with a task modifies a value of an attribute of the task, the description of the interaction by the user includes an identifier of the attribute of the modifier of the task and the modified value of the task. In some embodiments, the description of the interaction includes an indication that the interaction changed at least one attribute of the task and may identify the attribute that was changed. Capturing interactions by users with tasks allows the data ingestion module 200 to populate the interaction log in the data store 260, providing a history of interactions with tasks by users over time.

The content presentation module 210 selects content for presentation to a user and generates one or more interfaces for displaying the content to the user. In various embodiments, the content presentation module 210 receives a request for content from the user including one or more criteria, selects one or more content items (e.g., tasks, interactions) having values of attributes satisfying one or more of the criteria, and generates an interface displaying results comprising information about the selected one or more content items to the user. The content presentation module 210 generates instructions for generating an interface and transmits the instructions to a client device 100, which executes the instructions to generate an interface presenting the results generated in response to the request to a user (e.g., information about one or more tasks selected by the content presentation module 210). In some embodiments, the request from the user includes display instructions specifying how an interface presents information about the selected one or more content items. For example, a request specifies a calendar view, so the content presentation module 210 generates an interface displaying information about one or more selected content items on a calendar, where information identifying a content item, or one or more attributes of a content item, are displayed on a portion of the calendar corresponding to a date associated with the content item (e.g., a data associated with the content item, an attribute of the content item, etc.). As another example, a request includes a specific value of an attribute of a content item, and the content presentation module 210 selects content items having the specific value of the attribute and generates instructions for an interface presenting the selected content items.

In various embodiments, the content presentation module 210 receives a request from a user to generate a report via a client device 100. The request includes one or more criteria for content included in the report and a format for displaying content in the report. The content presentation module 210 retrieves content items, such as tasks or other data objects accessible to the task management system 130, having attributes that satisfy at least a threshold amount of criteria included in the request. To generate the report, the content presentation module 210 generates instructions that include the retrieved content items and instructions for displaying the retrieved content items subject to the format included in the report. The content presentation module 210 transmits the instructions for the report to the client device 100, which executes the instructions to generate the report.

As further described below in conjunction with FIGS. 3 and 4, to simplify retrieval of content items by a user, the content presentation module 210 receives a request from the user comprising unstructured text, such as natural language, and applies a tool selection model to the request. The tool selection model determines a tool of a set of tools maintained by the content presentation module 210 for the request. Each tool of the set of tools corresponds to a different expected result for the request, so different expected results present different types of information about content items in different formats. As further described below in conjunction with FIGS. 3 and 4, the tool selection model is a trained model that determines a tool of the set of tools based on content included in the request (as well as contextual information associated with the request in some embodiments).

The content presentation module 210 also maintains associations between each tool of the set of tools and a corresponding set of query building models. For example, the data store 260 includes a query building index that includes associations between identifiers of tools and sets of query building models. In some embodiments, different sets of query building models include different numbers of query building models. A query building model generates one or more features of a structured language query based on the request. When generating one or more features of a structured language query, a query building model may retrieve contextual information associated with the request from the data store 260 and generate one or more features of the structured language query based on the request and the contextual information. Features of a structured language query include an identifier of an attribute and a value of the attribute, one or more commands receiving an identifier of an attribute, an identifier of a source of content items to which the structured language query is applied, or other information.

Based on the tool determined for the request, the content presentation module 210 applies the set of query building models associated with the determined tool to the request (and, optionally, contextual information associated with the request) to generate a structured language query for the request. As the determined tool identifies the set of query building models applied to the request, determination of the tool allows the content presentation module 210 to convert the request into a structured language query with a suitable format for retrieving one or more types of content items based on the request. Subsequently, the content presentation module 210 executes the generated structured language query to retrieve one or more content items based on the request from the data store 260 or from a third party system 110. For example, each retrieved content item has a value of an attribute that at least partially matches a value of the attribute included in the request.

To simplify review of the retrieved content items, the content presentation module 210 applies a results generation model to the retrieved content items. As further described below in conjunction with FIGS. 3 and 4, in various embodiments, the content presentation module 210 ranks the retrieved content items based on corresponding scores. A score of a retrieved content item indicates a measure of relevance of the retrieved content item to the user from whom the request was received. The content presentation module 210 generates a prompt for input to the results generation model that includes the retrieved content items and a formatting instruction associated with the determined tool. In some embodiments, the prompt also includes one or more attributes of each of the retrieved content items, and the retrieved content items and associated attributes are included in the prompt in an order based on the ranking. The results generation model generates results for presentation to the user from whom the request was received based on the retrieved content items included in the prompt and the formatting instruction included in the prompt, as further described below in conjunction with FIGS. 3 and 4. The content presentation module 210 transmits the results to a client device 100 of the user from whom the request was received for presentation, simplifying retrieval and viewing of various content items by the user.

The search module 220 receives a search query from a client device 100 and retrieves search results comprising tasks, or other data objects, having attributes that at least partially satisfy the search query. Data objects may be documents, video files, audio files, or other files accessible to the search module 220. The data objects may be locally stored in the data store 260 or may be obtained from one or more third party systems 110 the task management system 130 is authorized to access. A search query is text for a word or set of words indicating attributes of a task or another data object. In various embodiments, the search module 220 generates a score for each task, or data object, at least partially satisfying the search query and presents the search results based on their corresponding scores. For example, the search module 220 scores tasks or other data objects based on a measure of relevance of a task or a data object to a search query. For example, the search module 220 applies natural language processing (NLP) techniques to text in the search query to generate a search query embedding representing characteristics of the search query. The search module 220 may use the search query embedding to score candidate items for presentation to a customer (e.g., by comparing a search query embedding to an item embedding) based on measures of similarity (e.g., cosine similarity, dot product, etc.) between the each query embedding and embeddings generated for tasks or data objects.

In some embodiments, a user authorizes the task management system 130 to access information associated with the user and stored by a third party system 110. In various embodiments, the search module 220 stores authentication information for the third party system 110 corresponding to the user in association with an identifier of the user and an identifier of the third party system 110. The authentication information for the third party system 110 may be a combination of a username and password or other authentication information identifying the user to the third party system 110 and indicating the user is authorized to access the third party system 110. In various embodiments, when the search module 220 receives a search query from the user, the search module 220, through one or more application programming interfaces (APIs), accesses a third party system 110 on behalf of the user. The search module 220 transmits the search query to the third party system 110 after accessing the third party system 110 with the authentication information provided by the user and retrieves files or other data objects from the third party system 110 that at least partially satisfy the search query. This allows the search module 220 to evaluate both locally stored data in the data store 260 and data maintained by a third party system 110 for the user for search results, providing search results for a search query that account for data objects associated with the user from one or more third party systems 110 the user authorized the task management system 130 to access.

The access control module 230 regulates access to tasks by various users. When a user accesses the task management system 130, the access control module 230 retrieves a user profile of the user from the user profile store 250. Based on one or more permissions in the user profile, the access control module 230 identifies a subset of tasks from the data store 260 that the permissions in the user profile of the user authorize the user to access. Tasks in the subset may be presented to the user or be otherwise accessible to the user, while tasks in the data store 260 and not in the subset are inaccessible to the user. Hence, the access control module 230 regulates access to stored tasks for different users.

Similarly, for a task, the access control module 230 determines a set of interactions a user is authorized to perform with the task based on one or more permissions in the user profile of the user. For example, a user with a first type of permission is authorized to modify one or more attributes of a task, while another user with a different type of permission is authorized to view the attributes of the task but is unable to modify one or more attributes of the task. As another example, one or more permissions of the user authorize the user to modify a specific set of attributes of the task, while preventing the user from modifying attributes that are not included in the specific set. The access control module 230 may receive permissions or modifications to permissions of a user from the user or from another user and store the permissions or the modified permissions in a user profile corresponding to the user. For example, a user profile of a user identifies an additional user authorized to modify one or more permissions associated with the user. This allows the access control module 230 to regulate types of interactions with a task based on permissions of a user, so different users are capable of performing different types of interactions with different tasks.

The machine learning training module 240 trains machine learning models used by the task management system 130. The task management system 130 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 240 generates the set of parameters for a machine learning model by “training” the machine learning model. Once trained, the machine learning model uses the set of parameters to transform inputs into outputs.

The machine learning training module 240 trains a machine learning model based on a set of training examples. Each training example includes input data to which the machine learning model is applied to generate an output. For example, each training example may include characteristics of a user, attributes of a task, attributes of a data object, data received from a user, or other data. In some cases, the training examples also include a label which represents an expected output of the machine learning model. In these cases, the machine learning model is trained by comparing its output from input data of a training example to the label for the training example.

The machine learning training module 240 may apply an iterative process to train a machine learning model whereby the machine learning training module 240 trains the machine learning model on each of the set of training examples. To train a machine learning model based on a training example, the machine learning training module 240 applies the machine learning model to the input data in the training example to generate an output. The machine learning training module 240 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 240 updates the set of parameters for the machine learning model based on the score generated by the loss function. For example, the machine learning training module 240 may apply gradient descent to update the set of parameters.

In various embodiments, the machine learning training module 240 tunes one or more generative models that receive a text prompt and generate content based on the text prompt. A generative model is a large language model (LLM), such as a generative pre-trained transformer model (GPT) in various embodiments. The generative model may generate text in response to a text prompt in various embodiments. Alternatively or additionally, the generative model selects or generates an image or another type of data in response to a text prompt. A generative model is pre-trained on a text corpus including text to learn relationships between different tokens comprising text input to the generative model. Examples of tokens include words or phrases. Based on the relationships between tokens learned during pre-training, the generative model generates output text based on text received as an input prompt. As another example, a generative model is a generative image model pre-rained on a corpus of images to output an image in response to a received text prompt before being obtained by the task management system 130. Obtaining a pre-trained generative model allows the machine learning training module 240 to leverage relationships between different text (or text and images) the generative model learned through application to a text corpus or image corpus including a larger amount of data and more varied data during pre-training than the task management system 130 maintains.

In various embodiments, the machine learning training module 240 generates examples for inclusion in a prompt that is input to a generative model. An example includes an input to the generative model and an expected output in response to the input. For example, an example includes input text and output text, with the output text provided in an expected format for the generative model. In various embodiments, when applying a generative model to input, the task management system 130 (e.g., the content presentation module 210) generates a prompt for the generative model that includes the input and one or more examples generated by the machine learning training module 240. Including the example in the prompt provides the generative model with information about a format or content of the output in the prompt itself. In some embodiments, the machine learning training module 240 generates an index including embeddings corresponding to various examples and corresponding examples to facilitate identification and retrieval of one or more examples to include in a prompt based on an embedding of an input to be provided to a generative model. The machine learning training module 240 stores the index including the supplemental examples, or the embeddings for the supplemental examples in the data store 260 in various embodiments.

In various embodiments, the machine learning training module 240 tunes a generative model to provide a specific type of output by applying the generative model to a set of training examples. Each training example includes an example input to the generative model, with a label applied to the training example specifying example output corresponding to the example input. To tune the generative model using a training example, the machine learning training module 240 applies the generative model to the example input in the training example to generate a predicted output. The machine learning training module 240 scores the predicted output from the generative model using a loss function. A loss function is a function that generates a score for the predicted output of the generative model such that the score is higher when the generative model performs poorly and lower when the generative model performs well. In cases where the training example includes a label, the loss function is also based on the label for the training example. Some example loss functions include the mean square error function, the mean absolute error function, and the cross-entropy loss function. The machine learning training module 240 updates at least a subset of parameters comprising the generative model based on the score generated by the loss function. For example, the machine learning training module 240 may apply gradient descent to update the subset of parameters.

In various embodiments, the machine learning training module 240 tunes a tool selection model to determine a tool from a set of tools for a request. As further described below in conjunction with FIG. 3, the tool selection model is a generative model in various embodiments, and the machine learning training module 240 applies the tool selection model to multiple tool selection training examples to tune the tool selection model for determining a tool for a request received as input. For example, each tool selection example includes an example request with a label applied to the tool selection example identifying a tool corresponding to the example request. Based on differences between a predicted tool for a tool selection training example determined by the tool selection model and the label applied to the tool selection model, the machine learning training module 240 modifies at least a subset of parameters comprising the tool selection model to refine the relationships between tokens previously learned by the tool selection model to determine a tool from the set of tools based on the received input (e.g., a request, a request and contextual information associated with the request).

Additionally, the machine learning training module 240 tunes multiple query building models to receive a request comprising text (e.g., natural language text, unstructured text) and generate a feature of a structured language query. A feature of the structured language query may be an identifier of an attribute of a content item and a value of the attribute of the content item, a source from which content items are obtained, one or more commands for identifying content items, or other information included in a structured language query to identify one or more content items. The machine learning training module 240 tunes a query building model to generate a feature for a structured language query based on a request received as input by applying the query building model to multiple query building training examples. For example, each query building example includes an example request with a label applied to the tool selection example identifying a feature of an example structured language query corresponding to the example request. Based on differences between a predicted feature for a query building training example determined by the query building model and the label applied to the query building model, the machine learning training module 240 modifies at least a subset of parameters comprising the query building model to refine the relationships between tokens previously learned by the query building model to determine a feature of a structured language query based on the received input (e.g., a request, a request and contextual information associated with the request).

Additionally, the machine learning training module 240 obtains a result generation model that comprises a generative model, such as a large language model (LLM). Prior to being obtained by the machine learning training module 240, the result generation model was pre-trained through application to a text corpus. Based on application to the text corpus, the result generation model learns relationships between different tokens in text received as input by the result generation model. Tokens may be individual words in the text received as input or phrases comprising multiple words in the text received as input. The result generation model leverages the learned relationships between tokens received as input to generate output text from the received input. As further described below in conjunction with FIGS. 3 and 4, the result generation model receives a prompt comprising retrieved content items (as well as attributes of different retrieved content items in some embodiments) and a formatting instruction and generates results including information about the retrieved content items presented in a format identified by the formatting instruction.

The user profile store 250 includes a user profile corresponding to each user of the task management system 130. A user profile of a user includes a user identifier of the user that uniquely identifies the user, characteristics of the user, contact information for the user, or other descriptive information about the user. In various embodiments, the user profile of the user includes task identifiers of tasks associated with the user. Further, in some embodiments, the user profile of the user includes one or more permissions of the user. The one or more permissions included in the user profile of a user identify types of interactions the user is permitted to perform with one or more tasks or tasks that the user is authorized to access. Different permissions may correspond to different tasks, allowing the user to perform different types of interactions with different tasks. A user profile may also maintain references to interactions the corresponding user performed on one or more tasks and that are stored in an interaction log in the data store 260. This allows the user to review or to identify one or more interactions the user previously performed with tasks by accessing the user's user profile.

The data store 260 stores data used by the task management system 130. For example, the data store 260 stores tasks created by a user. In various embodiments, the data store 260 includes a task log that includes a task identifier for each task with corresponding attributes of a task associated with the task identifier. For example, the task log includes multiple entries, with each entry including a task identifier for a task and attributes of the task associated with the task identifier. As further described above, example attributes of the task include: an identifier of a performing user assigned to perform the task, a status of the task, a due date for the task, a priority level of the task, a resource allocation (e.g., a budget) for performing the task, one or more comments about the task, or other information relevant to performing an action corresponding to the task.

Additionally, the data store 260 stores an interaction log describing interactions by users with the task management system 130. The interaction log includes an entry for each interaction by a user with a task. An entry in the interaction log includes a task identifier, a user identifier of a user who performed an interaction, a time when the interaction was performed, and a description of the interaction. The description of the interaction may be a type of the interaction and may include data received through the interaction. For example, an interaction is a comment on a task, and a description of the interaction includes a type indicating a comment and text data comprising the comment. As another example, a description of an interaction includes an attribute of a task modified by the interaction and a modified value for the attribute received via the interaction. In various embodiments, the interaction log organizes entries chronologically, while in other embodiments, the interaction log may organize entries using other formats.

In various embodiments, the data store 260 includes logs, databases, or other storage schema that store other types of data objects. For example, the task management system 130 obtains data objects, such as documents, video data, audio data, image data, or other files from a third party system 110 and stores the obtained data objects in a database corresponding to the third party system 110. Different databases are maintained for different third party systems 110 in various embodiments. Further, the data store 260 may store files or other data received from users of the task management system 130, such as files associated with or related to one or more tasks associated with the user.

As used herein, the term “content item” refers to discrete portions of content stored by the data store 260. Examples of a content item include: a task, an interaction, a user profile, a document, an image, audio data, a web page, or other types of data capable of being stored in the data store 260. Each content item has one or more associated attributes that are also stored in the data store. Different types of content items are stored in different formats by the data store 260. For example, the task log includes specific attributes of a task, while the interaction log stores different specific attributes of an interaction. Further, different information is used to identify different content items. For example, a task identifier of a task has a different format than a user identifier of a user profile. As further described below in conjunction with FIGS. 3 and 4, the content presentation module 210 leverages a trained tool selection model, a set of query building models, and a result generation model to simplify retrieval of one or more content items based on a request received from a user.

Additionally, the data store 260 stores contextual information describing requests for content items received from a user. Different types of contextual information may be included in the data store 260. For example, global contextual information stored by the data store 260 describes a user from whom a request for content items was received. As another example, historical request contextual information includes prior requests for content items received from the user and attributes of the prior requests for content items. In various embodiments, the data store 260 includes an identifier of a prior request and associates attributes of the prior request with the identifier. Example attributes of a prior request include: the content of the prior request, results generated by the content presentation module 210 based on the prior request, a structured language query generated for the prior request, contextual information associated with the prior request retrieved by the content presentation module 210, or other information associated with the prior request.

In some embodiments, the data store 260 includes a tool index including an entry for each tool of a set of tools. As further described below in conjunction with FIGS. 3 and 4, a tool corresponds to expected results of a request. So a tool identifies information about content items to include in results and retrieval of content items. Different tools cause retrieval of different content items by the content presentation module 210, as well as affect information about retrieved content items included in results based on a received request. Each entry in the tool index includes an identifier of a tool, a set of query building models associated with the tool, and a formatting instruction associated with the tool. Hence, the tool index allows the content presentation module 210 to retrieve a set of query building models for generating a structured language query from a request based on a tool determined for the request and to retrieve a formatting instruction describing information about content items retrieved based on the structured language query to include in results generated for the request. This simplifies retrieval of content items by a user, allowing the request received from the user to be independent of syntax structure for the structured language query, with the set of query building models corresponding to a tool determined for the request generating an appropriate structured language query from the request.

The data store 260 also stores trained machine learning models trained by the machine learning training module 240. For example, the data store 260 may store the set of parameters for a trained machine learning model on one or more non-transitory, computer-readable media. As another example, the data store 260 stores parameters comprising a previously trained model that the machine learning training module 240 obtained from a third party 110 or from another source. For example, the data store 260 includes the tool selection model, multiple query building models, and the result generation model that the machine learning training module 240 obtained, and optionally tuned in various embodiments. The data store 260 may also include one or more examples that a machine learning model, such as the result generation model receives as input. In various embodiments, the data store 260 stores an index including various examples and corresponding embeddings of the examples to facilitate retrieval of an example. The data store 260 uses computer-readable media to store data, and may use databases to organize the stored data.

FIG. 3 is a flowchart of a method for retrieving stored content items using a structured language query generated by a set of generative models based on a received request, in accordance with some embodiments. Alternative embodiments may include more, fewer, or different steps from those illustrated in FIG. 3, and the steps may be performed in a different order from that illustrated in FIG. 3. These steps may be performed by the task management system 130, or by another online system, in various embodiments. Additionally, each of these steps may be performed automatically by the task management system 130 without human intervention.

As further described above in conjunction with FIG. 2, a task management system 130 stores tasks created by one or more users and interactions with tasks by one or more users. The task management system 130 also stores other data in various embodiments, such as files or other data objects associated with one or more tasks and user profiles of users. Further, the task management system 130 may obtain data objects from one or more third party systems 110 that a third party system 110 maintains for a user and that the user has authorized the task management system 130 to access. This allows the task management system 130 to maintain or to access different types of data.

The term “content item,” as used herein, refers to discrete portions of content stored by the task management system 130 (e.g., in the data store 260). Examples of a content item include: a task, an interaction, a user profile, a document, an image, audio data, a web page, or other types of data capable of being stored in the data store 260. Each content item has one or more associated attributes that are also stored in the data store. Different types of content items have different associated attributes. For example, one or more attributes associated with a task are different than one or more attributes associated with an interaction with the task.

In various embodiments, the task management system 130 stores different types of content items in different formats. For example, the task management system 130 maintains a task log of tasks created by users in a task log having a specific format, and maintains an interaction log storing interactions with tasks by users in an alternative format. Similarly, the task management system 130 may store data objects obtained from a third party system 110 in a third party system database that includes different fields or different types of data than the task log or the interaction log. Using different formats for storing different types of content items allows the task management system 130 to optimize storage capacity of the data store 260 or to optimize retrieval time of content items from the data store 260.

While storing different types of content items in different formats allows the task management system 130 to optimize storage or retrieval of data, storing different types of content items in different formats involves using instructions or commands with different syntaxes to retrieve different types of content items. For example, the task management system 130 uses instructions having a particular syntax to identify criteria for retrieving tasks from the task log, but uses instructions having an alternative syntax to identify criteria for retrieving interactions from the interaction log. Similarly, other types of content items are retrieved using instructions with differing syntaxes to account for differences in attributes of the different types of content items or differences in how attributes of different types of content items are identified. This variation in syntax for instructions to retrieve different types of content items increases an amount of interaction with the task management system 130 by a user when retrieving content items, as the user manually enters instructions complying with syntax requirements for retrieving a particular type of content item. Additionally, differentiating between differing syntax structures for different types of content items increases an amount of complexity for a user to retrieve different types of content items, reducing a frequency with which the user interacts with the task management system 130.

To simplify retrieval of content items for a user, the task management system 130 receives 305 a request for one or more content items from the user. In various embodiments, the request comprises unstructured text data, such as natural language text. The request includes one or more values for one or more attributes used to identify content items. For example, the request includes one or more keywords, an identifier of a user, or other values for one or more other attributes of content items. For example, a search element or other interface element in an interface generated by a task management application executing on a client device 100 receives the request from the user, and the task management system 130 receives the request from the client device 100. In various embodiments, the task management application receives the request in response to receiving a specific interaction with the interface by the user to initiate creation of the request.

In response to receiving 305 the request, the task management system 130 determines 310 a tool for the request. The task management system 130 maintains a set of tools, with each tool corresponding to different expected results based on the request. A tool identifies information about content items to include in results based on the query and information about retrieval of content items. Different tools cause retrieval of different content items by the content presentation module 210, as well as specify information about retrieved content items included in results based on a received request. Each tool is associated with syntax information for a structured language query for retrieving content items based on the request. For example, a tool includes syntax information for retrieving content items from a particular source (e.g., particular database) that have values included in the request for a particular set of fields, while another tool includes syntax information for retrieving content items from an alternative source that have values included in the request for a different set of fields. As further described below, the syntax information associated with a tool is a set of query building models in various embodiments.

The task management system 130 applies a tool selection model to the received request to determine 310 the tool for the request. In various embodiments, the tool selection model receives the request as input. Further, in some embodiments, the tool selection model receives the request and contextual information associated with the request as input. Contextual information may be stored in the data store 260 and retrieved by the task management system 130 when applying the tool selection model. One or more different types of contextual information associated with the request may be retrieved and combined with the request to determine 310 the tool for the request. For example, a type of contextual information comprises global contextual information about the user from whom the request was received and the request. Examples of global contextual information include a user identifier of the user, an indication of tasks the user is authorized to access, an attribute of tasks associated with the user, a location associated with the user, a date or a time when the request was received, or other information providing information about the user or about the request.

Another type of contextual information maintained by the task management system 130 comprises historical request contextual information that includes prior requests received from the user and attributes of the prior requests. In some embodiments, the historical request contextual information includes prior requests received from the user during a specific time interval. For example, the historical request contextual information includes prior requests the task management system 130 received between a time when the user selects a specific interface element or when the task management system 130 receives a specific instruction from the user and the user performed a specific interaction (e.g., logged out of the task management interface, transmitted an alternative instruction to the task management system 130). Historical request contextual information for a prior request includes the content included in the request (e.g., text comprising the request) and one or more attributes of the prior request. Example attributes of a prior request include: prior results generated by the task management system 130 in response to the prior request, a tool determined for the prior request, a structured language query generated by the task management system 130 for the prior request, additional contextual information retrieved for the prior request when determining the tool for the prior request, or other information describing the prior request or describing generation of prior results for the prior query by the task management system 130. However, different contextual information about the user or about prior requests received from the user may be stored in various embodiments. The task management system 130 may retrieve different contextual information for input to the tool selection model in conjunction with the request in different embodiments.

The tool selection model is a generative model pre-trained on a text corpus including text to learn relationships between different tokens in input text. Tokens may be individual words or phrases in text in various embodiments. For example, the generative model is a large language model (LLM), such as a generative pre-trained transformer model (GPT), as further described above in conjunction with FIG. 2. Pre-training the tool selection model on the text corpus allows the tool selection model to leverage a larger quantity of text data than the task management system 130 maintains to learn relationships between different tokens in input text. The text corpus used for pre-training includes a larger amount of data and more varied data than maintained by the task management system 130.

While the tool selection model learns relationships between different tokens in input text from its pre-training, the task management system 130 further tunes the tool selection model to specifically output a tool for the request based on the request (and, optionally, contextual information associated with the request). For tuning, the task management system 130 uses a specific tool selection training dataset including multiple tool selection training examples to improve accuracy of the tool selection model in selecting a tool corresponding to the request. A tool selection training example includes an example request (and may include contextual information associated with the request), with a label applied to the tool selection training example identifying a tool corresponding to the example request. In various embodiments, the task management system 130 tunes the tool selection model by applying the tool selection model to each tool selection training example of the tool selection training dataset. The tool selection model determines a predicted tool when applied to a tool selection example based on the example request included in the tool selection training example. For each tool selection training example, the task management system 130 scores the tool selection model using a loss function based on a difference between the predicted tool determined by the tool selection model when applied to the tool selection training example. In various embodiments, the score is an error term generated by the loss function. Example loss functions include a mean square error function, a mean absolute error, a hinge loss function, and a cross-entropy loss function.

The task management system 130 backpropagates the error term to update at least a subset of parameters comprising the tool selection model and stops backpropagation in response to the error term, or in response to the loss function, satisfying one or more criteria. For example, the tool selection model comprises multiple layers of parameters, and the task management system 130 backpropagates the error term through a subset of layers of the tool selection model to update the subset of parameters of the tool selection model until the error term has less than a threshold value. As another example, the task management system 130 backpropagates the error term through each layer of the tool selection model to update parameters of the tool selection model until the error term has less than a threshold value. For example, the task management system 130 may apply gradient descent to update the subset of parameters of the tool selection model. The task management system 130 stores the set of parameters comprising the tuned tool selection model on a non-transitory computer readable storage medium, such as the data store 260, after stopping the backpropagation. Modifying the subset of parameters of the tool selection model based on application to the tool selection training examples further refines the pre-training of the tool selection model so the tool selection model is adapted to determine 310 a tool from the set of tools for the request based on the request (and, optionally, contextual information associated with the request).

As the tool corresponding to the request is based on an expected results based on the received request, the tool determined 310 by the tool selection model provides information to the task management system 130 about retrieving content items likely to be relevant to the request. Additionally, the tool determined 310 for the request specifies information about retrieved content items to include in the results and how to format the specified information in the results. Based on the tool determined 310 for the request, the task management system 130 selects 315 a set of query building models, which generate features of a structured language query for retrieving content items based on the request.

In various embodiments, the task management system 130 stores an association between a tool and a set of query building models, and the task management system 130 selects 315 the set of query building models associated with the tool determined 310 for the request. For example, the task management system 130 maintains a tool index in the data store 260, with the tool index having an entry corresponding to each tool of the set of tools. An entry in the tool index includes an identifier of a tool, a set of query building models associated with the tool, and a formatting instruction associated with the tool. The tool index also stores syntax information for a different structured language queries associated+with each tool of the set of tools. Different structured language queries have different syntaxes and include different features, so storing syntax information in the tool index allows the task management system 130 to determine how to combine features generated by different query building models. In some embodiments, a tool is associated with a single query building model, while in other embodiments, the tool is associated with multiple query building models. Different sets of query building models may include different numbers of query building models.

A query building model may be associated with multiple tools, allowing different tools to leverage a feature for a structured language query generated by the query building model. Different query building models generate different features of a structured language query. A feature of a structured language query includes a value of one or more attributes of a content item and identifiers corresponding to each of the one or more attributes in a format in which the content item is stored. The format used for the identifies of the one or more attributes is based on a source (e.g., a database) from which the content item is retrieved, and a query building model may determine the source of the content item in some embodiments. For example, a feature generated by a query building model includes a value of a user identifier for a particular user and an identifier of a field corresponding to user identifiers in a particular database where a content item is stored. As another example, a query building model identifies values of one or more keywords from the request and identifies identifiers of fields corresponding to each of the one or more keywords in a database from which content items are to be retrieved. Query building models may receive contextual information associated with the request along with the request in some embodiments. Different query building models may obtain different contextual information associated with the request. For example, a query building model is applied to the request and to historical request contextual information associated with the request, while another query building model is applied to the request and to global contextual information associated with the request. Other query building models may receive the request itself as input without associated contextual information. A single query building model generates multiple features of a structured language query from the request and, optionally, from contextual information associated with the request in some embodiments.

From the features generated by applying the selected set of query building models to the request, the task management system 130 generates 320 a structured language query for the request. A query building model selected 315 based on the tool corresponding to the request generates one or more features of the structured language query, as further described above. A query building model is a generative model pre-trained on a text corpus to learn relationships between different tokens comprising input text. A token may be an individual word in the input text or may be a phrase in the input text. For example, the query building model is a large language model (LLM), such as a generative pre-trained transformer model (GPT), as further described above in conjunction with FIG. 2. Pre-training the query building model on a text corpus allows the query building model to learn relationships between different tokens through application to a text corpus that includes a larger amount of text and more varied text than maintained by the task management system 130.

While the query building model to learn relationships between different tokens in input text through pre-training, the task management system 130 further tunes the query building model for specifically generating one or more features of a structured language query from text comprising a request. For example, a feature generated by a query building model comprises a value of an attribute of a content item and an identifier of the attribute used by a format in which the content item is stored (e.g., based on a source from which the content item is retrieved). Hence, the tuning adapts general relationships between tokens learned by the query building model during pre-training to generate features of a structured language query through application to multiple query building training examples. Applying the query building model to multiple query building training examples increases accuracy of the query building model for generating features for a structured language query from the request, and, optionally, contextual information associated with the request.

A query building example includes an example request (and may include contextual information associated with the example request), with a label applied to the query building training example identifying one or more features based on the example request (and contextual information associated with the example request in some embodiments). The task management system 130 tunes the query building model by applying the query building model to each query building training example of the query building training dataset. Applying the query building model to a query building training example generates one or more predicted features based on the example request included in the query building training example. For each query building training example, the task management system 130 scores the query building model using a loss function based on a difference between the one or more predicted features generated by application of the query building model to a query building training example and a label applied to the query building training example. In various embodiments, the score is an error term generated by the loss function. Example loss functions include a mean square error function, a mean absolute error, a hinge loss function, and a cross-entropy loss function.

The task management system 130 backpropagates the error term to update at least a subset of parameters comprising the query building model and stops backpropagation in response to the error term, or in response to the loss function, satisfying one or more criteria. For example, the query building model comprises multiple layers each including parameters of the query building model, and the task management system 130 backpropagates the error term through a subset of layers of the query building model to update a subset of parameters of the query building model until the error term has less than a threshold value. As another example, the task management system 130 backpropagates the error term through each layer of the query building model to update parameters of the query building model until the error term has less than a threshold value. For example, the task management system 130 may apply gradient descent to update a set of parameters of the query building model. The task management system 130 stores the set of parameters comprising the tuned query building model on a non-transitory computer readable storage medium, such as the data store 260, after stopping the backpropagation. Modifying the subset of parameters of the query building model based on application to query building training examples refines the relationships between tokens of an input learned during pre-training of the query building model t to optimally generate one or more features for a structured language query based on the request (and, optionally, contextual information).

In various embodiments, different query building models are tuned using different query building training datasets. For example, different query building training datasets correspond to different features of the structured language query, so a first query building training dataset has query building training examples to which a label identifying a specific attribute and a value of the specific attribute are applied, while a second query building training dataset has query building training examples to which a different label identifying an alternative attribute and a value of the alternative attribute is applied. A query building training example may be included in query building training datasets for different features, with the query building training example having a particular example request and different labels applied to the query building training example identifying different attributes and corresponding values when included in different training datasets.

Based on the features for the structured language query generated from applying the selected set of query building models to the request (and to contextual information associated with the request), the task management system 130 generates 320 the structured language query for the request. The task management system 130 combines the generated features subject to syntax information associated with the tool determined 305 for the request to generate 320 the structured language query for the request. Features generated by the set of query building models from the request (and contextual information associated with the request) are included in the structured language query to specify values of attributes of content items identified by the request. As further described above, the task management system 130 stores syntax information in association with different tools, with syntax information associated with a tool specifying a format and an order in which features generated by query building models are combined to generate 320 the structured language query. For example, the task management system 130 generates 320 an application programming interface (API) call including instructions and features generated by the one or more query building models selected 315 based on the determined tool combined based on the syntax information associated with the determined tool. The syntax information associated with the determined tool maps different features to different commands and specifies an order in which commands and features are included in the API call. Hence, the syntax information associated with the tool selected 315 for the request and the features generated from the request by the selected query building models convers the request into a structured language query capable of being executed by the task management system 130.

In various embodiments, the task management system 130 obtains supplemental information for one or more features generated by the query building models when generating 320 the structured language query. For example, the task management system 130 converts a feature generated by a query building model to an alternative format for inclusion in the structured language query. As an example, a query building model generates a feature comprising a name of a user, and the task management system 130 maps the name of the user to a user identifier of the user for inclusion in the structured language query. The task management system 130 converts a feature to an alternative format using one or more indices or databases that include associations between features and indices. In various embodiments, a source determined by a query building model determines an index the task management system 130 uses to convert a feature to an alternative format. For example, the task management system 130 maintains an index mapping a feature to an alternative format for a task log and an additional index mapping the feature to an alternative format for an interaction log. A query building model identifies the task log or the interaction log, and the task management system 130 accesses a corresponding index to convert the feature to an appropriate alternative format.

The task management system 130 retrieves 325 one or more content items by executing the structured language query. In various embodiments, the structured language query includes one or more identifiers of one or more sources from which content items are retrieved along with values of one or more attributes and identifiers of the corresponding attributes of content items to retrieve from an identified source. For example, the structured language query includes a name or other identifier of a database maintained by the data store 260, and the task management system 130 compares a value included in the structured language query for an attribute identified by the structured language query to values of the attribute for different content items included in the identified database. The task management system 130 retrieves 325 one or more content items (e.g., tasks, interactions, files, etc.) with a value of an attribute in the identified source (e.g., database) at least partially matching the value of the attribute included in the structured language query. As another example, the structured language query includes an identifier of a third party system 110, an instruction to retrieve content items, identifiers of attributes, and values corresponding to each identified attribute. The task management system 130 retrieves 325 content items from the third party system 110 having values of one or more attributes maintained by the third party system 110 that at least partially match values for the corresponding attributes included in the structured language query.

The task management system 130 ranks 330 the content items retrieved 325 from execution of the structured language query. In various embodiments, the task management system 130 generates a score for each retrieved content item, with the score for a retrieved content item based on values of one or more attributes of the retrieved content item. The score for a retrieved content item provides a measure of relevance of the retrieved content item to the user from whom the request was received 305 in various embodiments. In various embodiments, a score for a retrieved content item is a combination of values of at least a set of attributes of the retrieved content items. Values for attributes of a retrieved content item may be weighted by a weight corresponding to an attribute, with the task management system 130 combining the weighted values of attributes of the set of attributes to determine a score for the retrieved content item. For example, the score is a sum of the weighted values of attributes of the set of attributes, while in other embodiments, the score is another combination of the weighted values of the attributes of the set of attributes. Example attributes of a retrieved content item for determining the score include: a number of interactions with the retrieved content item by users of the task management system 130, a time interval between a most recent interaction with the retrieved content item and a time when the retrieved content item was retrieved 325, comments associated with the retrieved content item by users of the task management system 130, a number of comments associated with the retrieved content item by users of the task management system 130, an indication whether the user from whom the request was received 305 created the content item or is assigned to the content item, or other information describing the content item. In various embodiments, attributes of a retrieved content item used to determine the score for the retrieved content item are dependent on a source from which the retrieved content item was retrieved 325, allowing the task management system 130 to account for variations between attributes maintained for different content items. The task management system 130 ranks 330 the retrieved content items based on their scores, with content items having higher scores having higher positions in the ranking.

In some embodiments, the task management system 130 obtains supplemental attributes of a retrieved content item that are used to determine the score for the retrieved content item. One or more supplemental attributes describe interactions with the retrieved content item by multiple users of the task management system 130. For example, a supplemental attribute of a retrieved content item is a number of times additional users in a group including the user from whom the request was received 305 accessed the retrieved content item or is a frequency with which additional users in the group including the user from whom the request was received 305 access the retrieved content item. A user profile of the user from whom the request was received 305 includes an identifier of a group including the user, which the task management system 130 identified to determine one or more interactions by other users in the group with a retrieved content item to determine one or more supplemental attributes of the retrieved content item. This allows one or more supplemental attributes of a retrieved content item to provide information about a popularity of the retrieved content item among other users in a group with the user from whom the request was received 305. The task management system 130 combines values for one or more supplemental attributes of a retrieved content item with values for attributes of the retrieved content item to generate a score for the retrieved content item in various embodiments. The task management system 130 applies weights to the supplemental attributes of a retrieved content item in various embodiments, and combines the weighted supplemental attributes and the weighted values of attributes of the set of attributes of the retrieved content item to generate the score for the retrieved content item in various embodiments.

In various embodiments, the task management system 130 generates different rankings for content items retrieved 325 from different sources (e.g., different databases). For example, the task management system 130 generates a source-specific ranking for each source from which content items were retrieved 315. A source-specific ranking for a particular source of retrieved content items ranks the content items retrieved 325 from the particular source and does not include content items retrieved 325 from other sources. Generating a source-specific ranking for retrieved content items from different sources allows the task management system 130 to account for different attributes of content items stored in different sources when ranking 330 retrieved content items. When the task management system 130 generates source-specific rankings for different sources, the task management system 130 subsequently generates a combined ranking including content items retrieved 325 from a plurality of sources. The combined ranking may be based on scores generated for retrieved content items for source-specific rankings, with the combined ranking ordering retrieved content items based on their corresponding scores for source-specific rankings. Alternatively, the task management system 130 generates an alternative score for each retrieved content item based on attributes of each retrieved content item and ranks 330 the retrieved content items based on the alternative scores. In some embodiments, the task management system 130 applies a conversion factor to scores generated for source-specific rankings to convert the scores for source-specific ranking into alternative sources used for ranking 330 content items from different sources. Generating the combined ranking allows the task management system 130 order of retrieved content items relative to each other based on measures of relevance of content items retrieved 330 from different sources to the user from whom the request was received 305.

Based on the ranking 330 of the retrieved content items, the task management system 130 generates 335 a prompt for a result generation model. The prompt includes the retrieved content items in an order determined by the ranking, with one or more attributes of each retrieved content item included in the prompt in conjunction with a corresponding retrieved content item. Ranking the retrieved content items based on scores indicating measures of relevance of different retrieved content items to the user allows the retrieved content items to be included in the prompt in an order that provides an indication of relative measures of relevance of different retrieved content items to the user from whom the request was received 305.

The task management system 130 includes a formatting instruction in the prompt along with the retrieved content items, and associated attributes, in the order determined by the ranking 330. For example, the task management system 130 appends the formatting instruction to the retrieved content items and their associated attributes. The formatting instruction describes a format for presenting results identifying at least a set of the retrieved content items. In various embodiments, the task management system 130 determines the formatting instruction based on the tool determined 310 for the request and appends the formatting instruction to retrieved content items and their associated attributes ordered based on the ranking 330. For example, the task management system 130 retrieves a formatting instruction associated with the determined tool from a tool index in the data store 260. In various embodiments, the formatting instruction comprises a combination of an example input to the result generation model and a corresponding example output. For example, the example input comprises an ordered list of example content items and associated attributes, and the example output includes one or more attributes of the example content items or information derived from attributes of the example content items presented in a specific format. Including the formatting instruction in the prompt provides the result generation model with an indication of information about retrieved content items to include in the results and how to format the information included in the results.

The task management system 130 generates 340 results including information about at least a set of the retrieved content items by applying the result generation model to the prompt. In various embodiments, the result generation model is a generative model, such as a large language model (LLM). As further described above in conjunction with FIG. 2, the result generation model is pre-trained through application to a text corpus before being obtained by the task management system 130. Pre-training through application to the text corpus allows the result generation model to learn relationships between different tokens (e.g., different words or phrases) comprising an input, which the result generation model leverages to generate results based on text included in a prompt received as input. Including the formatting instruction in the prompt provides the result generation model with an expected format of content in the results, providing the result generation model with descriptive information for determining how to format information about the retrieved content items in the results and information about retrieved content items to include in the results. For example, a formatting instruction causes the generated results to include a total number of content items that were retrieved 325, while an alternative formatting instruction causes the generated results to identify each retrieved content item and one or more attributes associated with each retrieved content item.

Generating 335 the prompt so the retrieved content items are ordered based on the ranking 330 allows the prompt to convey relative relevance of different retrieved content items to the user from whom the request was received 305 to the result generation model. Without ordering the retrieved content items based on their ranking 330, the result generation model may inefficiently organize information about the retrieved content items when generating 340 the results, which may increase an amount of time the user from whom the request was received 305 spends reviewing the results. As many generative models inaccurately reorder received inputs when summarizing the received inputs, using the ranking 330 of the retrieved content items when generating 335 the prompt allows the prompt to leverage the ordering of the content items to simplify organization of information about retrieved content items by the result generation model.

The task management system 130 transmits 345 the generated results to a client device 100 of the user from whom the request was received 305. In response to receiving the results, the client device 100 presents the results to the user for review. For example, the client device 100 displays the results to the user in a portion of an interface generated by a task management application. In some embodiments, the task management application dynamically presents tokens comprising the results of the result generation model in an interface, so the task management application updates the interface over time to present different tokens comprising the results generated 340 by the result generation model. For example, the task management application executing on the client device 100 maintains a buffer of tokens comprising the results received from the task management system 130 and retrieves tokens from the buffer for presentation at a rate based on an amount of tokens in the buffer. In various embodiments, the rate at which tokens are retrieved from the buffer for presentation (e.g., display) is proportional to a percentage of the buffer including tokens. For example, a rate at which tokens are retrieved from the buffer is greater when a larger percentage of the buffer includes tokens comprising the results and is less when a smaller percentage of the buffer includes tokens comprising the results. The rate at which tokens are retrieved from the buffer for presentation changes as tokens are retrieved from the buffer and presented, allowing the results to be presented to the user in a more continuous manner than presenting all of the tokens in the buffer at once. Hence, as a number of tokens included in the buffer decreases from presentation of tokens from the buffer, the rate at which tokens are retrieved from the buffer or presentation decreases. This prevents the user from experiencing delays between presentation of different portions of the results from the task management application requesting additional portions of the results from the task management system 130.

In other embodiments, the task management system 130 maintains the buffer including one or more tokens comprising the results generated 340 by the result generation model and adjusts a rate at which tokens from the buffer are transmitted to the client device 100 for presentation based on an amount of tokens in the buffer. For example, the rate of transmission of tokens from the buffer to the client device 100 is proportional to an amount of tokens included in the buffer. As an example, the rate of transmission of tokens from the buffer to the client device 100 is higher when a larger percentage of the buffer includes tokens and is lower when a smaller percentage of the buffer includes tokens. The task management system 130 dynamically modifies the rate of transmission as tokens are retrieved and transmitted from the buffer, so the rate of transmission decreases as an increasing number of tokens are retrieved from the buffer and transmitted in various embodiments.

The combination of the tool selection model and associated set of query building models simplifies retrieval of content items from the task management system 130 for a user. Rather than have the user manually enter a structured language query applicable to a specific type of content item to be retrieved, the tool selection model and the set of query building models generates a structured language query with an appropriate format for retrieving a type of content item based on a natural language, or otherwise unstructured, request from the user. Having the task management system 130 generate a structured language query for retrieving content items reduces an amount of interaction by the user with the task management system 130 to retrieve content items.

FIG. 4 is a process flow diagram of a method for retrieving stored content items using a structured language query generated by a set of generative models based on a received request. As further described above in conjunction with FIGS. 1-3, a task management system 130 receives tasks from users. Each task identifies an action to be performed and includes a performing user assigned to perform the action. Further, each task is associated with one or more attributes providing information about the task, as further described above in conjunction with FIGS. 1-3. The task management system 130 stores the received tasks and their corresponding attributes for subsequent retrieval. For example, the task management system 130 maintains a task long in a data store 260 including an entry for each task, as further described above in conjunction with FIGS. 2 and 3.

Additionally, users of the task management system 130 perform interactions with one or more tasks, with an interaction with a task modifying one or more attributes of the task. In various embodiments, the task management system 130 maintains an interaction log as a record of interactions with tasks by users. For example, the task long includes an entry for each interaction, with an entry including an identifier of an interaction and attributes of the interaction. Further, the task management system 130 may obtain other data objects associated with a user or with a task from one or more third party systems 110 (or from a client device 100). For data objects obtained from a third party system 110, a user of the task management system 130 authorizes the task management system 130 to obtain data objects maintained by the third party system 110 for the user. Example data objects include: documents, audio data, image data, or other data having one or more attributes. The task management system 130 locally stores data objects obtained from a third party system 110 in a database corresponding to the third party system 110 in some embodiments. For example, the task management system 130 maintains different databases for different third party systems 110 and stores objects obtained from a third party system 110 in a database corresponding to the third party system 110. For clarity, the term “content item” is used herein to refer to discrete portions of data with one or more attributes that are stored, or otherwise accessible, by the task management system 130. For example, a content item may be a task, an interaction, a user profile, a file, a data object, or other type of data stored by the task management system 130 and having one or more corresponding attributes stored by the task management system 130. A content item has a type based on the discrete portion of data represented by the content item, so example types of a content item include a task, an interaction, a user profile, a data object, or other type of data.

To optimize storage resources or to optimize retrieval time of stored content items, the task management system 130 stores data about different types of content items in different formats. For example, the task management system 130 maintains a task log for tasks comprising a database with specific fields corresponding to different attributes and maintains an interaction log comprising a separate database with different fields corresponding to various attributes of an interaction. Different databases may be maintained for different types of content items, with each database storing different attributes for a corresponding type of content item. Storing different types of content items in different formats causes instructions or commands with different formats and including different information to be used for retrieving content items from different databases. For example, an instruction for retrieving a task from the task log has a different syntax and identifies different attributes than an instruction for retrieving an interaction from the interaction log. This variation in syntax in instructions for retrieving different types of content items increases complexity of a user retrieving different types of content items. Determining an appropriate format for instructions to retrieve different types of content items increases an amount of time spent by a user to retrieved content items or increases an amount of interaction by the user with the task management system 130 to retrieved various content items, which may reduce subsequent interaction with the task management system 130 by the user.

To simplify retrieval of content items, regardless of type, the task management system 130 receives a request 400 to retrieve one or more content items from a user. For example, the request 400 comprises natural language or unstructured text in various embodiments. In various embodiments, the request 400 includes one or more values of attributes of content items to retrieve. For example, the request 400 includes a specific keyword or a specific time interval as values for one or more attributes of content items to be retrieved. In the example of FIG. 4, the request 400 includes an identifier of a type of content item to retrieve, “tasks,” and a value, “accounting,” for a specific attribute of content items to retrieve. In various embodiments, the request 400 includes different numbers of values for different attributes, allowing different requests to provide different levels of specificity for content items to retrieve.

The task management system 130 applies a tool selection model 405 to the received request 400. As further described above in conjunction with FIG. 3, the task management system 130 maintains a set 410 of tools for obtaining results based on the request 400. Different tools of the set 410 correspond to different expected results based on the result, so different tools cause the task management system 130 to differently retrieve content items and to include different information about retrieved content items in results generated based on the request 400. For example, a first tool of the set 410 corresponds to expected results of an aggregated number of content items (e.g., tasks), while a second tool of the set corresponds to expected results of a listing of content items having a value for an attribute included in the request 400. In various embodiments, the task management system 130 maintains different numbers of tools in the set 410.

The tool selection model 405 is a generative model pre-trained on a text corpus to determine relationships between different tokens (e.g., different words, different phrases) included in an input before being obtained by the task management system 130. For example, the tool selection model is a large language model, such as a generative pre-trained transformer model. As further described above in conjunction with FIG. 3, the task management system 130 further refines the tool selection model 405 to determine a tool 415 from the set 410 of tools for the request 400 by applying the tool selection model 405 to tool selection examples. Each tool selection example includes an example request, with a label applied to the tool selection example indicating a tool corresponding to the example request. In some embodiments, the tool selection example includes contextual information associated with the example request, as further described above in conjunction with FIG. 3. When the task management system 130 applies the tool selection model 405 to a tool selection example, the task management system 130 modifies at least a set of parameters comprising the tool selection model 405 based on a difference between a predicted tool output by the tool selection model 405 for the tool selection example and the label applied to the tool selection example. This parameter modification of the tool selection model improves an accuracy with which the tool selection model 405 to determines a tool 415 for the request 400 based on correspondences between example requests and tools.

In various embodiments, the task management system 130 stores one or more types of contextual information describing the user from whom the request 400 was received and additional requests received from the user from whom the request 400 was received, as further described above in conjunction with FIG. 3. Contextual information may be stored in the data store 260 and retrieved by the task management system 130 when applying the tool selection model 405 to the request 400. A type of contextual information comprises global contextual information about the user from whom the request 400 was received and the request 400. Examples of global contextual information include a user identifier of the user, an indication of tasks the user is authorized to access, an attribute of tasks associated with the user, or other information describing the user or the request.

Another type of contextual information comprises historical request contextual information including prior requests the task management system 130 received from the user and attributes of the prior requests. In some embodiments, the historical request contextual information includes attributes of prior requests received from the user during a specific time interval. The historical request contextual information is limited to prior requests received from the user during a time interval when the user is logged in to the task management system 130 using authentication information for the user in some embodiments. For each prior request, the task management system 130 stores the content included in the prior request (e.g., text comprising the prior request) and maintains one or more attributes for the prior request. Example attributes of a prior request include: prior results generated by the task management system in response to the prior request, a tool determined for the prior request, a structured language query generated by the task management system for the prior request, additional contextual information about the prior request retrieved and included in the structured language query generated for the prior request, or other information associated with the prior request. Different types of characteristics of the user may be included in the global contextual information or different attributes associated with prior requests may be included in the historical request contextual information in various embodiments. The task management system 130 may retrieve different sets of contextual information the tool selection model 405 receives in conjunction with the request 400 in different embodiments.

Applying the tool selection model 405 to the request, as well as to contextual information associated with the request 400, determines a tool 415 for the request 400. Based on the tool 415 determined for the request 400, the task management system 130 selects a set 420 of query building models for application to the request 400 to generate a structured language query 425 from the request 400. As further described above in conjunction with FIG. 3, in various embodiments, the task management system 130 stores associations between each tool of the set 410 of tools and a corresponding set 420 of query building models. While different tools are associated with different sets 420 of query building models, one or more query building models may be included in multiple sets 420 of query building models associated with different tools. In some embodiments, each tool of the set 410 of tools is associated with a single query building model, while in other embodiments, multiple query building models are associated with a tool. Further, different numbers of query building models may be included in sets 420 of query building models associated with different tools of the set 410 of tools.

The task management system 130 selects a set 420 of query building models associated with the tool 415 determined for the request 400 and applies each query building model of the set 420 to the request 400. In various embodiments, each query building model of the set 420 receives the request 400 and associated contextual information as input. Different query building models of the selected set 420 of query building models may retrieve different contextual information associated with the request 400. For example, a first query building model receives the request 400 and global contextual information associated with the request 400 as input, while a second query building model receives the request 400 and historical request contextual information associated with the request 400 as input. A query building model of the set 420 generates one or more features of the structured language query 425 based on the request 400 and associated contextual information. For example, different query building models generate different combinations of a value of an attribute and an identifier of an attribute or generate parameters for different commands based on the request 400 (and, optionally, contextual information associated with the request 400). Hence, the selected set 420 of query building models converts the unstructured or natural language text of the request 400 into features representing different portions of a query having a specific syntax.

In various embodiments, each query building model is a generative model pre-trained on a text corpus including text to learn relationships between different portions of text within a received input. For example, the query building model is a large language model (LLM), such as a generative pre-trained transformer model (GPT), as further described above in conjunction with FIGS. 2 and 3. While pre-training the query building model on the text corpus allows the query building model to discern relationships between different tokens (e.g., different words, different phrases) in an input, the task management system 130 further tunes a query building model to generate one or more features of the structured language query 425 based on the request 400 and contextual information associated with the request 400 through a backpropagation process from application to query building training examples. A query building training example includes an example request (and may include contextual information associated with the example request), with a label applied to the query building training example identifying one or more features based on the example request (and contextual information associated with the example request). Applying the query building model to a query building training example generates a predicted feature. The task management system 130 modifies a subset of parameters comprising the query building model based on a difference between the predicted feature and the label applied to the query building training example. Hence, applying the query building model to query building training examples adapts the more general pre-training of the query building model to generate features of the structured language query 425 based on the request 400 and associated contextual information.

In various embodiments, the task management system 130 combines features generated by each of the set 420 of query building models selected based on the tool 415 to generate the structured language query 425 determined for the request 400. For example, the task management system 130 stores syntax information for different types of structured language queries that correspond to different tools of the set 410 of tools. In various embodiments, the task management system 130 maintains a tool index that associates each tool of the set 410 of tools with a corresponding set 420 of query building models, corresponding syntax information, and a corresponding formatting instruction, as further described above in conjunction with FIG. 3. As different structured language queries have different syntaxes and include different features, maintaining the tool index allows the task management system 130 to account for variations in syntax of structured language query. Syntax information for a structured language query 425 includes an identifier of a source (e.g., a database) from which content item are retrieved in various embodiments.

The task management system 130 generates the structured language query 425 by combining features generated by different query building models of the set 420 subject to the syntax information associated with the tool 415 determined for the request 400 in various embodiments. For example, the structured language query 425 comprises an application programming interface (API) call including instructions and features generated by the one or more query building models of the set 420 that are combined subject to syntax information associated with the tool 415 determined for the request 400. However, in other embodiments, the structured language query 425 has one or more alternative formats.

The task management system 130 executes the structured language query 425 to retrieve one or more content items 445. The structured language query 425 specifies a source from which the task management system 130 retrieves content items in various embodiments. Example sources from which content items 445 are retrieved include a task log 430, an interaction log 435, or a data object store 440 included in the data store 260 of the task management system 130. As another example, a source of one or more content items 445 is a third party system 110. The task management system 130 may retrieve the content items 445 based on the structured language query 425 from multiple sources in some embodiments. Each content item 445 retrieved based on the structured language query 425 has a value of at least one attribute matching a value included in the structured language query 425. Hence, the tool selection model 405 and the corresponding set 420 of query building models generate the structured language query 425 based on the request 400. The task management system 130 subsequently executes the structured language query 425 to retrieve content items 445 with values of one or more attributes satisfying values included in the request 400.

To simplify review or evaluation of information about content items 445 retrieved based on the structured language query 425 by the user from whom the request 400 was received, the task management system 130 ranks the retrieved content items 445. In some embodiments, the task management system 130 generates a score for each content item 445 based on values of attributes of a retrieved content item 445. As further described above in conjunction with FIG. 3, the task management system 130 may obtain supplemental attributes of a retrieved content item 445 and generate the score for the retrieved content item 445 based on the supplemental attributes and values of attributes of the retrieved content item 445. Example supplemental attributes of a content item 445 include: a number of interactions with the content item 445, a number of a specific interaction performed with the content item 445, comments associated with the content item 445, or other information describing access to the content item 445 by the user or by users with a common characteristic as the user. The score of a content item 445 provides a measure of relevance of the content item 445 to the user from whom the request 400 was received. In some embodiments, the task management system 130 applies different weights to values of attributes or supplemental attributes of the content item 445 and combines the weighted values to generate the score for the content item 445. The task management system 130 ranks the retrieved content items 445 based on their scores, with content items having higher scores having higher positions in the ranking.

In various embodiments, the task management system 130 generates different rankings for content items 445 retrieved from different sources. For example, the task management system 130 generates a source-specific ranking for each source from which content items 445 were retrieved. A source-specific ranking for a particular source of retrieved content items 445 ranks the content items 445 retrieved from the particular source. Generating source-specific rankings for content items 445 retrieved from different sources allows the task management system 130 to account for different attributes of content items 445 maintained by different sources. When the task management system 130 generates source-specific rankings for content items 445 retrieved from different sources, the task management system 130 subsequently generates a combined ranking including content items 445 retrieved from a plurality of sources. The combined ranking may be based on scores generated for source-specific rankings for content items 445. Alternatively, the task management system 130 generates an alternative score for each retrieved content item 445 based on attributes of each retrieved content item and ranks the retrieved content items 445 for the combined ranking based on the alternative scores. In various embodiments, the task management system 130 generates the alternative score for a content item 445 by applying a conversion factor to the score generated for the source-specific ranking for the content item 445. The combined ranking allows the task management system 130 to provide an order of content items 445 retrieved from different sources relative to each other based on measures of relevance to the user from whom the request 400 was received.

Based on the ranking of the retrieved content items and a formatting instruction 450 associated with the tool 415 determined for the request 400, the task management system generates a prompt 455 for a result generation model 460. The formatting instruction 450 describes a format in which information about at least a set of the retrieved content items 445 is presented to the user from whom the request 400 was received. In various embodiments, the task management system 130 determines the formatting instruction 450 based on the tool 415 determined for the request 400 and appends the formatting instruction to retrieved content items 445 and their associated attributes ordered based on the ranking to generate the prompt 455. As further described above in conjunction with FIG. 3, the task management system 130 maintains a tool index storing associations between each tool of the set 410 of tools and a corresponding set 420 of query building models for a tool, corresponding syntax information for the tool, and a corresponding formatting instruction for the tool. The task management system 130 stores the tool index in the data store 260 in various embodiments. As further described above in conjunction with FIG. 3, in various embodiments, the formatting instruction 450 comprises an example set of content items and example results presenting information about the example set of content items to present. The formatting instruction identifies the information to include in results and descriptive information for how the identified information is presented to the user from whom the request was received 400. Including the formatting instruction in the prompt 455 provides the result generation model 460 with an indication of information to include in the results and how to format the information included in the results.

Applying the result generation model 460 to the prompt 455 generates results 465 including information about at least a set of the content items 445. In various embodiments, the result generation model is a generative model, such as a large language model (LLM). As further described above in conjunction with FIGS. 2 and 3, the result generation model 460 is pre-trained through application to a text corpus before being obtained by the task management system 130. The pre-training allows the result generation model 460 to learn relationships between different tokens (e.g., different words or phrases included in the input) comprising an input, which the result generation model 460 leverages to generate results 465 based on tokens included in the prompt 455. Including the formatting instruction 450 in the prompt 455 provides the result generation model 460 with an expected format of content in the results 465, the result generation model 460 uses in combination with the learned relationships between tokens in the prompt 455 to generate results 465 presenting information about the content items 445 formatted based on the formatting instruction 450. For example, in response to a formatting instruction 450, the result generation model 460 generates results 465 including a total number of content items 445 that were retrieved. As another example, in response to an alternative formatting instruction 450 the result generation model 460 generates results 465identifying each retrieved content item 445 and one or more attributes associated with each retrieved content item 445.

The task management system 130 transmits the results 465 to a client device 100 of the user from whom the request 400 was received, which presents the results 465 to the user. In various embodiments, a task management application executing on the client device 100 displays the results 465 in a portion of an interface. As further described above in conjunction with FIG. 3, the task management application or the task management system 130 modifies a rate at which portions of the results 465 are displayed or presented to the user based on a portion of the results 465 that has been presented relative to a size of the results. Such variability in presentation of the results 465 prevents delays in the user being presented with different portions of the results 465 over time. However, in other embodiments, the task management system 130 or the task management application differently presents the results 465 to the user.

Applying the tool selection model 405 to the request 400 and subsequently applying a set 420 of query building models corresponding to a determined tool 415 to the request 400 generates a structured language query 425 based on the request 400. As the task management system 130 stores different types of content items (e.g., tasks, data objects, or interactions) in different formats, queries for retrieving different types of content items have differing syntaxes or include differing information. The tool selection model 405 and the set 420 of query building models simplify retrieval of content items by converting the request 400, which may be unstructured text, into an appropriately formatted structured language query 425 for retrieving content items based on the content of the request 400 (as well as contextual information about the request 400 in various embodiments). Subsequently, the task management system 130 retrieves content items 445 based on the structured language query 425 and generates results 465 by applying the result generation model 460 to the retrieved content items 445. The results 465 include information about one or more of the retrieved content items 445 and present the information about the one or more content items 445 in a format based on the determined tool 415, reducing an amount of time for the user to review or to evaluate the results 465. Hence, the task management system 130 leverages the tool selection model 405, a set 420 of query building models selected based on the tool 415 determined by the tool selection model 405, and the result generation model 460 to simplify retrieval of content items and presentation of information about retrieved content items for a user.

The embodiments disclosed herein provide a technical improvement in the functionality of computer systems, such as data management systems. For example, the disclosed embodiments provide technical improvements for data retrieval systems by providing more intuitive interface for users to retrieve and to present content maintained by a data management system or other computing system. By leveraging a tool selection model trained to determine a tool corresponding to unstructured text, the embodiments disclosed herein determine a set of query building models based on the determined tool that convert the unstructured text into a structured language query for retrieving particular information. This prevents users from complying with different syntax rules or structures for one or more structure language queries, instead allowing users to provide unstructured language that the tool selection model and a set of query building models automatically convert into a structured language query for retrieving data by a data management system, such as the task management system. This provides users with an intuitive interface for retrieving stored data that uses simplified unstructured language received from a user to identify and to retrieve stored data rather than providing instructions or commands in a specific, specialized format used by the data management system.

Furthermore, the tool selection model automatically determines a formatting instruction associated with the tool determined for the unstructured text received from a user that describes a format in which information about at least a set of the retrieved content items retrieved based on the structured language query generated for the unstructured text is presented to a user. By determining the formatting instruction based on the tool determined for the unstructured text, the disclosed embodiments generate specific interfaces for different tools that include different descriptive information about content items, or other data, retrieved from the data management system based on the structured language query generated based on the unstructured text received from a user. Determining the formatting instruction based on the determined tool allows generation of different interfaces for retrieved data based on unstructured text from a user, rather than providing a common interface in response to input from a user or having a user manually identify or describe formatting of an interface in addition to identifying features or attributes of content to retrieve. Such automatic generation of an interface based on unstructured text provides a technical improvement by simplifying both retrieval of content from a data management system and subsequent review or analysis of the retrieved data by adjusting information about retrieved content items that is provided based on the unstructured text.

### Additional Considerations

The foregoing description of the embodiments has been presented for the purpose of illustration; a person of ordinary skill in the art would recognize that many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A method, performed at a computer system comprising a processor and a non-transitory computer readable medium, comprising:
receiving a request for one or more content items from a client device of a user at the computer system, the request comprising unstructured text;
determining a tool from a set of tools for generating one or more structured language queries for the request by applying a tool selection model to the request, the tool selection model comprising a generative model tuned by:
obtaining a plurality of tool selection training examples, each tool selection training example including an example request and having a label indicating a tool for the example request;
applying the tool selection model to each tool selection training example to generate a predicted tool for a tool selection training example;
scoring the tool selection model using a loss function based on the predicted tool for the tool selection training example and the label of the tool selection training example; and
updating a subset of parameters of the tool selection model by backpropagation based on the scoring until one or more criteria are satisfied;
generating a structured language query for the request by applying each of a set of query building models associated with the determined tool to the request, each query building model comprising a generative model applied to the request to generate a feature of the structured language query, the structured language query specifying a source of content items associated with the determined tool, with the feature of the structured language query having a format based on the source of content items associated with the determined tool;
retrieving, from the computer system, one or more content items each having a value of an attribute at least partially matching a value of the attribute included in the structured language query;
ranking the retrieved one or more content items based on scores generated for each of the retrieved one or more content items based corresponding attributes of the one or more content items;
generating a prompt including the one or more retrieved content items in an order based on the ranking and a formatting instruction associated with the determined tool;
generating results for the request by applying a results generation model to the prompt, the results generation model comprising a large language model; and
transmitting the results from the computer system to the client device of the user for presentation.

2. The method of claim 1, wherein each tool selection training example includes the example request and contextual information associated with the example request, and wherein determining the tool from the set of tools for generating one or more structured language queries for the request by applying the tool selection model to the request comprises:
determining the tool by applying the tool selection model to the request and to contextual information associated with the request.

3. The method of claim 2, wherein the contextual information comprises one or more of a group consisting of: a user identifier of the user, an indication of tasks maintained by the computer system the user is authorized to access, an attribute of tasks associated with the user, a location associated with the user, a date or a time when the request was received, and any combination thereof.

4. The method of claim 2, wherein the contextual information comprises attributes of one or more prior requests the computer system received from the user, attributes of a prior request selected from a group consisting of: content included in the prior request, prior results generated by the computer system in response to the prior request, a tool determined for the prior request, a structured language query generated by the computer system for the prior request, and any combination thereof.

5. The method of claim 4, wherein the one or more prior requests were received from the user after the computer system receives a specific instruction from the user.

6. The method of claim 2, wherein each query building model is applied to the request and contextual information associated with the request.

7. The method of claim 6, wherein different query building models of the set are applied to the request and to different contextual information associated with the request.

8. The method of claim 1, wherein ranking the retrieved one or more content items based on scores generated for each of the retrieved one or more content items based corresponding attributes of the one or more content items comprises:
for each of the one or more content items:
retrieving values of each of a set of attributes of a content item;
for each attribute of the set, applying a weight corresponding to an attribute of the set to a retrieved value of the attributes of the set; and
generating the score for the content item as a combination of the weighted values of each of the set of attributes of the content item; and
ranking the retrieved one or more content items based on the scores.

9. The method of claim 8, wherein one or more attributes of the set of attributes of the content item comprise one or more supplemental attributes selected from a group consisting of: a number of a specific interaction performed with the retrieved content item, comments with the retrieved content item, a frequency with which users accessed the content item, a number of times additional users in a group including the user accessed the content item, a frequency with which additional users in the group including the user access the retrieved content item, and any combination thereof.

10. The method of claim 1, wherein transmitting the results from the computer system to the client device of the user for presentation comprises:
transmitting tokens comprising the results retrieved from a buffer to the client device of the user at a rate based on a percentage of a buffer including the tokens comprising the results.

11. A computer program product comprising a non-transitory computer readable storage medium having instructions encoded thereon that, when executed by a processor, cause the processor to perform steps comprising:
receiving a request for one or more content items from a client device of a user at a task management system, the request comprising unstructured text;
determining a tool from a set of tools for generating one or more structured language queries for the request by applying a tool selection model to the request, the tool selection model comprising a generative model tuned by:
obtaining a plurality of tool selection training examples, each tool selection training example including an example request and having a label indicating a tool for the example request;
applying the tool selection model to each tool selection training example to generate a predicted tool for a tool selection training example;
scoring the tool selection model using a loss function based on the predicted tool for the tool selection training example and the label of the tool selection training example; and
updating a subset of parameters of the tool selection model by backpropagation based on the scoring until one or more criteria are satisfied;
generating a structured language query for the request by applying each of a set of query building models associated with the determined tool to the request, each query building model comprising a generative model applied to the request to generate a feature of the structured language query, the structured language query specifying a source of content items associated with the determined tool, with the feature of the structured language query having a format based on the source of content items associated with the determined tool;
retrieving, from the task management system, one or more content items each having a value of an attribute at least partially matching a value of the attribute included in the structured language query;
ranking the retrieved one or more content items based on scores generated for each of the retrieved one or more content items based corresponding attributes of the one or more content items;
generating a prompt including the one or more retrieved content items in an order based on the ranking and a formatting instruction associated with the determined tool;
generating results for the request by applying a results generation model to the prompt, the results generation model comprising a large language model; and
transmitting the results from the task management system to the client device of the user for presentation.

12. The computer program product of claim 11, wherein each tool selection training example includes the example request and contextual information associated with the example request, and wherein determining the tool from the set of tools for generating one or more structured language queries for the request by applying the tool selection model to the request comprises:
determining the tool by applying the tool selection model to the request and to contextual information associated with the request.

13. The computer program product of claim 12, wherein the contextual information comprises one or more of a group consisting of: a user identifier of the user, an indication of tasks maintained by the task management system the user is authorized to access, an attribute of tasks associated with the user, a location associated with the user, a date or a time when the request was received, and any combination thereof.

14. The computer program product of claim 12, wherein the contextual information comprises attributes of one or more prior requests the task management system received from the user, attributes of a prior request selected from a group consisting of: content included in the prior request, prior results generated by the task management system in response to the prior request, a tool determined for the prior request, a structured language query generated by the task management system for the prior request, and any combination thereof.

15. The computer program product of claim 14, wherein the one or more prior requests were received from the user after the task management system receives a specific instruction from the user.

16. The computer program product of claim 12, wherein each query building model is applied to the request and contextual information associated with the request.

17. The computer program product of claim 16, wherein different query building models of the set are applied to the request and to different contextual information associated with the request.

18. The computer program product of claim 11, wherein ranking the retrieved one or more content items based on scores generated for each of the retrieved one or more content items based corresponding attributes of the one or more content items comprises:
for each of the one or more content items:
retrieving values of each of a set of attributes of a content item;
for each attribute of the set, applying a weight corresponding to an attribute of the set to a retrieved value of the attributes of the set; and
generating the score for the content item as a combination of the weighted values of each of the set of attributes of the content item; and
ranking the retrieved one or more content items based on the scores.

19. The computer program product of claim 18, wherein one or more attributes of the set of attributes of the content item comprise one or more supplemental attributes selected from a group consisting of: a number of a specific interaction performed with the retrieved content item, comments with the retrieved content item, a frequency with which users accessed the content item, a number of times additional users in a group including the user accessed the content item, a frequency with which additional users in the group including the user access the retrieved content item, and any combination thereof.

20. The computer program product of claim 11, wherein transmitting the results from the task management system to the client device of the user for presentation comprises:
transmitting tokens comprising the results retrieved from a buffer to the client device of the user at a rate based on a percentage of a buffer including the tokens comprising the results.
